(19) United States
(12) Patent Application Publication
(10) Pub. No.: US 2008/0300844 A1
(43) Pub. Date: Dec. 4, 2008

(54) METHOD AND SYSTEM FOR ESTIMATING PERFORMANCE OF RESOURCE-BASED SERVICE DELIVERY OPERATION BY SIMULATING INTERACTIONS OF MULTIPLE EVENTS

(75) Inventors: Sugato Bagchi, White Plains, NY (US); Daniel P. Connors, Pleasant Valley, NY (US); Shubir Kapoor, Shrub Oak, NY (US); Kaan Katircioglu, Yorktown Heights, NY (US); Young M. Lee, Old Westbury, NY (US); Wei Wang, Beijing (CN)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/757,111

(22) Filed: Jun. 1, 2007

(51) Int. Cl. G06F 17/50

(52) U.S. Cl. 703/13

(57) ABSTRACT

Method and system for estimating performance of resource-based service delivery operation by simulating interactions of multiple events are provided. Method and system, in one aspect, simulate a plurality of events associated with a resource-based service delivery operation and allow the plurality of events to interact through a resource availability outlook. The plurality of events may include events of execution of service engagement and at least one or more of demand planning of service engagement, supply planning of resources, attrition of resources, termination of resource, or combinations of thereof.

### FIELD OF THE INVENTION

The present disclosure relates generally to simulation models, and particularly to a method and system for estimating performance of service delivery operation by simulating interactions of multiple events.

### BACKGROUND OF THE INVENTION

Service operations such as consulting, call center, technical service and IT outsourcing, contribute to a large portion of the U.S. and world economy. Process modeling and simulation have been used for many years to analyze performance of manufacturing processes, supply chain processes and other business processes. Bagchi, S., Buckley, S., Ettl, N., Lin, G. 1998, Experience Using the IBM Supply Chain Simulator, In Proceedings of the 1998 Winter Simulation Conference, D. J. Medeiros, E. F. Watson, J. S. Carson and M. S. Manivannan, eds., for example, describes a supply chain simulation modeling. However, it is difficult to apply those analytic tools developed for manufacturing and supply chain to service businesses, because service businesses operate quite differently and involve more complex factors. Therefore, not many structured modeling methods are available for analyzing performance of service businesses. Unlike most supply chains, the service (human) resource is perishable, and the skill set of resource is diverse and inexact. The skill levels also change through training and engagement experiences. The resource requirements for service engagement are also complex and inexact; therefore, the bill-of-resources (BOR) is much difficult to model than bill-of-materials (BOM) in supply chain. Moreover, the availability of resource is also degraded over time due to attrition and termination of workforce. All these factors have made the modeling and simulation of service businesses very difficult.

Another difference between service operation and manufacturing/supply chain is that many more complicated policies are used in service operations. For example, resource acquisition part of the supply planning may have complicated policies on whether and how much specific number of resources should be hired or contracted or re-trained. For retraining itself, there can be many policies regarding who should be re-trained, and how long the training should be.

There have been only a handful of simulation studies done for service business, further the existing studies focus on a small subset of service businesses. Anderson, E., Morrice, D., 1999, A Simulation Model To Study The Dynamics in a Service-Oriented Supply Chain, In Proceeding of the 1999 Winter Simulation Conference, used system dynamics modeling to study correlation between capacity planning and backlog for simplified mortgage approval process. Akkernans, H, Vos, B., 2000, Amplification in Service Supply Chains: An Exploratory Case Study from the Telecome Industry, Production and Operations Management, 2000, also used system dynamics modeling to study upstream amplification of workload in the service supply chain (telecommunication business). However, there has not been any simulation model that describes the interactions of engagement/resource planning, execution of service orders, as well as resource management in a more detailed and discrete level for resource-intensive service businesses. Effectiveness of availability management process in supply chain has been modeled and simulated by Lee, Y. M. 2007, Analyzing the Effectiveness of Availability Management Process, In Trends in Supply Chain Design and Management: technologies and Methodologies. Jung, H., Chen, F. F., Jeong, B., (eds.). Springer. That work models the effectiveness of availability (materials such as products and components) management on supply chain performance, but does not address service operations, which is different and more complex to model since service operations involve dealing with availability of human resources. Therefore, it is desirable to have a simulation model and method that can model and simulate those and other factors in service operations, so that for example, resource management and other planning for those operations can be analyzed and/or optimized.

### BRIEF SUMMARY OF THE INVENTION

A method and system for estimating performance of resource-based service delivery operation by simulating interactions of multiple events are provided. The method, in one aspect, may comprise simulating a plurality of events associated with a resource-based service delivery operation and allowing the plurality of events to interact through a resource availability outlook. The plurality of events may include events of execution of service engagement and one or more of planning events such as demand planning of service engagement, supply planning of resources, attrition of resources, or termination of resource, or combinations thereof.

A system for estimating performance of resource-based service delivery operation by simulating interactions of multiple events, in one aspect, may include a processor operable to simulate a plurality of events associated with a resource-based service delivery operation, the processor further operable to allow the plurality of events to interact through a resource availability outlook.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a diagram illustrating an overview of simulation model of the present disclosure in one embodiment.

FIG. 2 is a diagram illustrating details of demand planning and supply planning simulation model components of the present disclosure in one embodiment.

FIG. 3 is a diagram illustrating the resource attrition and resource termination modules in detail in one embodiment of the present disclosure.

FIG. 4 is a diagram illustrating engagement execution of service order module of the present disclosure in one embodiment.

FIG. 5 is a flow diagram illustrating a method of the present disclosure in one embodiment.

### DETAILED DESCRIPTION

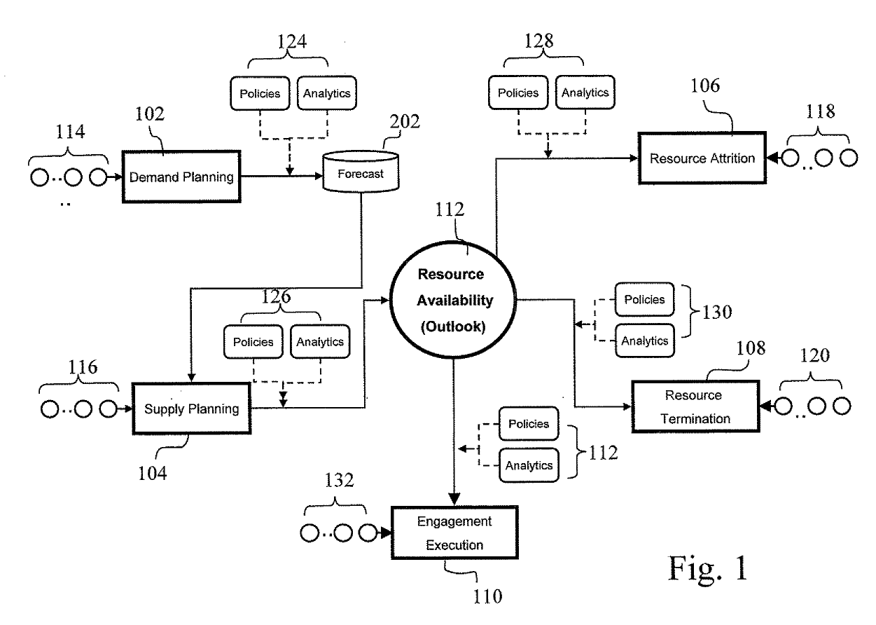

FIG. 1 is a diagram illustrating an overview of simulation model of the present disclosure in one embodiment. The framework of FIG. 1 shows as example modules or functionalities of resource-based service business: demand planning of service engagement 102, supply planning of human resources 104, attrition of resources 106, termination of resources 108 and execution of service engagement orders 110 using discrete-event simulation (DES) method. Not all or more than the five shown may be used or applied in the method and system of the present disclosure. Each of these modules may interact with others through a notion of availability outlook 112, which may include a view of resource availability with respect to specific skill set, time period, line of business, locations, skill level, etc. An example of resource availability outlook may include, but is not limited to, the number of expert Java Programmers available in weekly time buckets starting this weeks and for following 12-month periods; for example, 10 people for this week, 12 people next week, 20 people for week after, etc. The resource availability outlook in one embodiment includes visibility of resources from now to a specified time in the future. Supply planning module 104 may increment the resource availability in the availability outlook, while the module of service order execution 110 may allocate the available resources to specific service order engagements and thus may decrement the availability accordingly. The modules of resource attrition 106 and resource termination 108 also may decrement the availability. The performance of service businesses can depend more on the interaction of these components than each individual one. For example, even if supply planning were done optimally, if the right resource is not allocated to the right engagement by project manager, the overall operation would suffer.

In one embodiment, the modeled modules, for example, 102, 104, 106, 108 and 110 each is triggered independently. For example, the demand planning 102 is carried out as a weekly or monthly event that produces forecasted demand by engagement types. The supply planning 104 is also carried out once a week or month, and uses the demand forecast, supply constraint and other criteria to convert expected future engagements to level of resources requirements. The outcome of supply planning adds resource to the resource availability outlook 112, which provides a view of resources into the future by resource attributes such as skill, location and line of business. Resource attrition 106 may occur as a random event that describes attrition of existing resources. The resource termination 108 is a human resource related module that may be triggered in a certain frequency to eliminate certain portion of resources with various reasons such as financial or efficiency reason. The resource attrition 106 and termination 108 take away resources from the resource availability outlook 112. An engagement execution 110 models service orders arriving at a service operation and fulfilling the engagement using information from the service availability outlook 112.

The method and system of the present disclosure in one embodiment simulate events (e.g., shown at 114, 116, 118, 120, 122) being triggered from the components of the service operations such as those shown in FIG. 1 (e.g., demand planning 102, supply planning 104, resource attrition 106, resource termination 108, engagement execution 110), and carrying out corresponding interacting activities based on the triggered events. The events 114, 116, 118, 120, 122 interact with one another by using and updating information in the resource availability outlook 112. Each event may use various policies or analytics (described in more detail below), e.g., shown at 124, 126, 128, 130, 132) in executing its tasks.

The effective interaction of the events as well as performance of individual event is manifested as business performance metrics such as revenue, profit, resource costs, service level as well as quality of service business. The method and system of the present disclosure in one embodiment may simulate various scenarios and estimate the performance metrics.

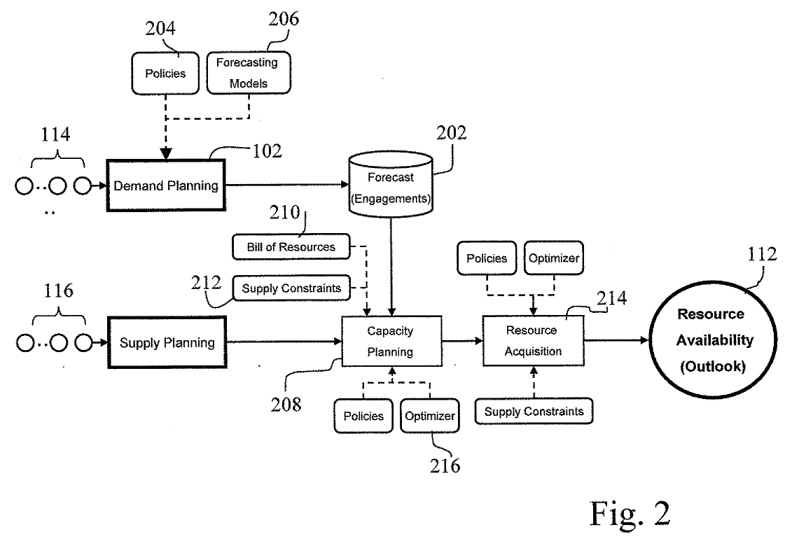

FIG. 2 is a diagram illustrating details of demand planning and supply planning simulation model components of the present disclosure in one embodiment. Demand planning 102 may produce forecasted demand 202, for example, by engagement type, also referred to as SPL (service product line), by engagement start time period (usually time bucket such as weekly or monthly level), duration and size of engagement. The forecast can be based on historic demand pattern, expected business growth and engagement opportunity in the pipeline. Demand may be forecasted by simple business insights (referred to as policies 204) or may be computed by various forecasting algorithm 206 such as time-series methods and/or methods based on partially known demand information and lead time. The demand forecast 292 is used by supply planning as shown in FIG. 2.

Supply planning 104 estimates resource requirements based on demand forecast 202 and decides the level of resource that should be acquired. One of the activities in supply planning may be resource capacity planning (RCP) 208. RCP 208 breaks data representing engagement forecast into resource requirement through explosion of BOR (Bill-of-Resources) 210. RCP 208 converts engagement forecast (e.g., grouped by SPL and by time periods) into resource requirement (for example, grouped by skill groups and by time periods). RCP 208 can also use information on supply constraint 212 and implode it to compute realistic quantity of engagement that can be fulfilled. RCP 208 computation can be done deterministically when demand forecast is given as a fixed number. When demand forecast is given with variability, RCP 208 can also compute resource requirement that includes resource buffer (safety resource) against the variability by optimizing expected values. The output of RCP 208 in one embodiment may be gaps (shortage) and gluts (surplus) of resource. The gaps and gluts are grouped, for example, by SPL and by time periods.

The gaps and gluts computed by RCP 208 may be used by resource acquisition activity 214 that decides how to acquire the additional resource. There may be several ways to acquire resources; for example, hiring additional resources, contracting temporary resource, retraining existing resources, etc. Hiring new resources (for example, employees) involves one time cost for hiring process such as advertising, interviewing or relocation etc., and on-going costs of salary and benefits once the resources are hired. Hiring also takes time. Depending on the skill sets that are sought, it may take a few months to bring some resources and have them be ready to be used for engagements. Once resources are hired, it is not so easy to terminate the resource due to complication of labor agreement and severance payment, etc. Contracting resources from resource agency is typically easier and faster than hiring, but typically costs significantly higher per utilization. Re-training existing resources which are not utilized is another option, but it could takes substantially longer depending which skill the resource are trained to and from. Engagement managers (or project managers), however, may be reluctant to train someone and prefer hiring or contracting the right resource with right skill sets as soon as possible. Therefore, resource acquisition task is complicated one that needs to consider costs, time, and/or service level. This problem may be formulated as a rich optimization problem that can be solved analytically. However, in current service industry, many service firms use rather simple policies to make decision of resource acquisition.

The method and system of the present disclosure in one embodiment may simulate many different policies, and also optimization models by interacting with them with data from the simulation run. The policies can be simple or more complicated. For example, the method and system may model the following polices; (1) hire when needed and hold, (2) consider hiring first, contracting next, (3) consider contracting first, then hiring, (4) consider retraining first then contracting and then hiring etc. Each policy can also specify parameters such as decision threshold on lead time, costs, backlog, etc. The resource acquisition optimizer may have an objective function of maximizing revenue (or profit) while satisfying constraints of service level agreement (SLA) and costs, etc.

The output of resource acquisition 214 in one embodiment may be a plan which specifies which resources would be becoming available at which period, for example, grouped by skill sets and by time periods. The resource acquisition 214 may update, for example, increment, the data according to its analysis, in the resource availability outlook 112.

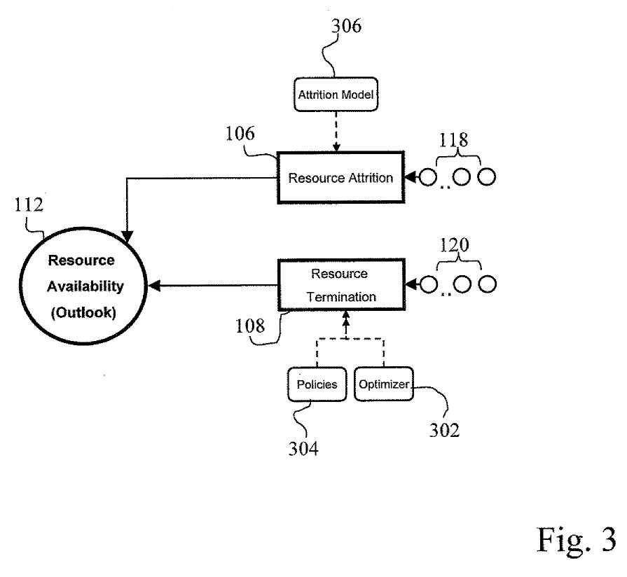

FIG. 3 is a diagram illustrating the resource attrition and resource termination modules in detail in one embodiment of the present disclosure. Typically resources in a service firm are not stationary, but can be reduced in numbers as a result of resignation, retirement, or death. Although, a service firm has number of employees and has a plan to acquire more, a level of attrition happens inevitably. Attrition depends on many things such as working environment, salary, age of employees, job market, types of skills, etc. The influence of those factors on attrition is intuitively understandable, but the exact correlation is not easy to define. In one embodiment, the resource attrition module 106 is a discrete-event simulation (DES) model. To estimate the dynamics of resource attrition, this module 106, for example, may interact with a continuous simulation model 306, e.g., a system dynamics (SD) model for resource attrition that provides causal relationship and feedback control mechanism. Resource attrition module 106 may update the resource availability outlook 112, for example, decrement the data in availability outlook based on its analysis output.

In resource-oriented service operations, underutilized resources are directly related to the financial performance of the firms. Resources (e.g., employees) are paid salary and are provided benefits regardless of whether they are engaged in projects (except a few operations, where employees are paid only when they are utilized). In fact, in consulting businesses, employees are typically let go if they are not utilized (also called benched) for a few months consecutively. Service operations usually monitor the benched resources and make periodic decision on whether, how many and which resources should be terminated. The system and method of the present disclosure simulate the termination event and activities.

Termination decisions may be based on many criteria or factors such as the cost of termination, for example, severance payment, union pressure, future prospect of the business, priority of skill sets and morale of other employees, etc. This may be modeled as optimization problem. A resource termination module may interact with such optimizers 302. One or more optimizers 302, for example, may use algorithms and mathematical computation to determine an optimum number for termination based on the simulated factors or events. Resource termination module 108 may also make its decisions based on policies 304, which can also be simulated in the simulation model of the present disclosure in one embodiment. Resource termination module 108 may determine its output based on one or more or combinations of determinations from the optimizers and policies. Output of the termination event is used to update (e.g., decrement) the resource availability outlook 112.

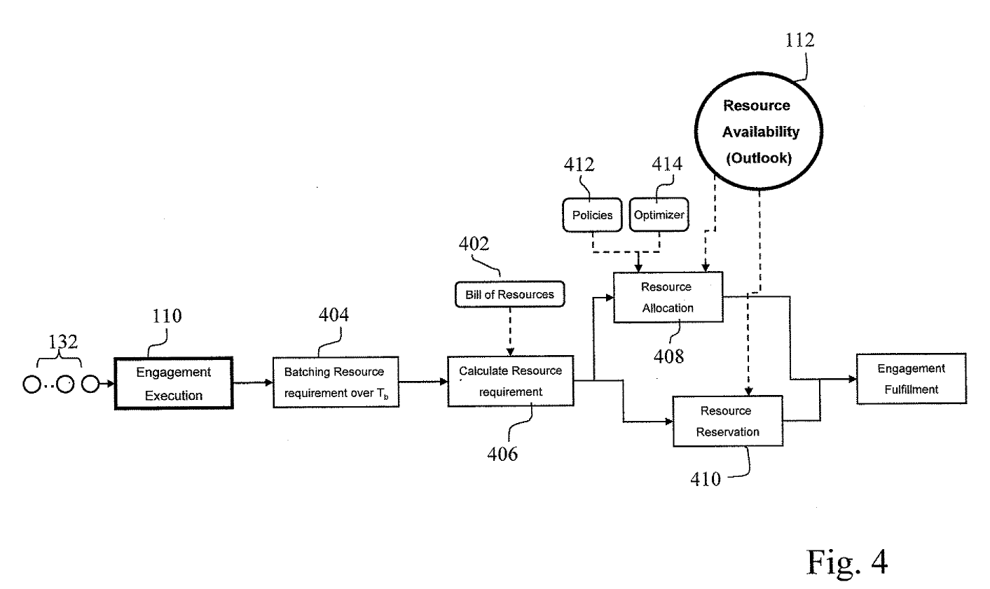

FIG. 4 is a diagram illustrating engagement execution of service order module of the present disclosure in one embodiment. In one embodiment, engagement execution module 110 is a dynamic module that simulates service order arrival, allocates resources to it, and fulfills the order. In one embodiment, service order arrivals may be modeled as a Poisson process. Each order, when arrived, may be characterized by assigning attributes such as service type (SPL for example), start date, duration, customer class, revenue, geographic location, etc. to the order. These attributes may be decided by random drawing from distribution function (or histogram) derived from historic data with anticipated future adjustment.

Each service order can be exploded with Bill-of-Resources (BOR) 402 and the required resource can be allocated one at a time as the order 132 is received. Briefly, to explode refers to computing or deriving total or net resource requirements. Allocating or reserving resources on demand immediately or substantially immediately may ensure on-time fulfillment of a particular engagement. Alternatively, it may be more efficient to batch up service orders by time interval, such as weekly or daily, and then simultaneously allocate or reserve resources for several service orders thus creating opportunity for optimal allocation of resources. As shown at 404, in the engagement execution simulation model in one embodiment, the batching frequency, T_{b}, can be specified as a simulation parameter. Or, the simulation model can also be set up such a way that each order is processed as soon as it arrives, or combinations of both.

The batched service orders are exploded together against BOR, and appropriate resources are identified (shown at 406) using the resource availability outlook 112. There may be different types of identifying resources against service orders. An example of one type is resource allocation 408. This is a firm allocation of specific resources against a service order that is due to start within the lead time of the resource acquisition. If a specific resource is not available for this firm allocation, the fulfillment of this service order is either backlogged (start date is delayed) or goes away as lost sales opportunity. An example of another type is resource reservation against service orders 410. For service orders that are due to start beyond lead time (e.g., there is enough time to acquire the required resources), resources are loosely reserved rather than firmly allocated. This allows for other service orders that would need the reserved resources for allocation if necessary. If there is not enough resources to be reserved for certain service orders, the backlog of reservation is computed and forwarded to demand planning module 114, which will include this as a part of demand forecast, and the service order would be put on-hold until after the next demand planning cycle, and re-scheduled. At each batching cycle, the reserved resources may be converted to allocated resources and the service order may be firmly scheduled.

Decision on resource allocation and reservation may be made based on different polices 412. One example of such policies may be a simple first-come first served (FCFS). Other policies may include, but not limited to, a rationing policy, which tries to distribute resources across various classes of service orders such as customers, geographic locations or time periods. The rationing policy further may have provisions such as even if a service order requests a resource, do not allocate if the resource needs to be used later for some other service orders. Yet other examples of policies may include revenue-based policy, profit-based policy, duration-based policy, etc. These policies may allocate resources with the goal towards maximizing revenue, profit, etc. A policy may be also designed to develop desirable skill sets for the future. For instance, a policy may allocate to a service order available resources comprising less experienced personnel, for example, so that those less experienced personnel can be built up to become highly skilled personnel in the future; such policy also may consider allocating experienced personnel in the availability resource outlook to an appropriate service order in such a way that the experienced personnel does not get easily bored.

The engagement execution module 110 updates (e.g., decrements) the resource availability outlook 112 when it allocates resources, and releases the resources back to the availability outlook with higher skill level (through the engagement experience), when engagement fulfillment is completed.

The method and system of the present disclosing, using the simulation model illustrated and described above in one embodiment, generates various performance metrics for service operations, including but not limited to, revenue, profit, profile of benched resource, fulfillment delay, backlog, lost sales opportunity and resource utilization. The metrics may be used to improve overall operations.

The method and system of the present disclosure in one embodiment provides a capability of plugging in various polices and analyzing the impact of the policies on the service operation performance. The method and system of the present disclosure in one embodiment can also interact with various optimization models. A supply planning may encompass several optimization problems, such as RCP (resource capacity planning) and RAP (Resource Acquisition Planning). When these optimization models are available, the simulation frame in the present disclosure can easily interact with such models, and evaluate their effects on the overall service business performance.

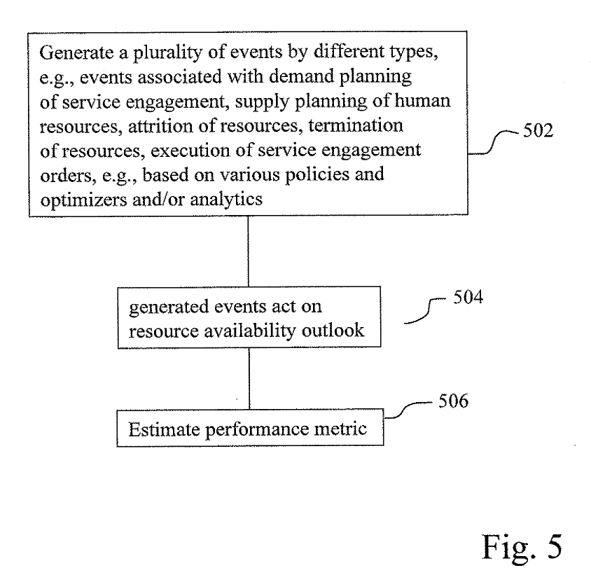

FIG. 5 is a flow diagram illustrating a method of the present disclosure in one embodiment. At 502, a plurality of events by different types are generated. In one embodiment, the types of events may include but are not limited to demand planning of service engagement, supply planning of human resources, attrition of resources, termination of resources, execution of service engagement orders. The events may use one or more policies to make resource decision. Further the events may use optimizers that make resource decision dynamically based on simulated data. At 504, the generated events act on a resource availability outlook. In one embodiment, the events may update the resource availability outlook, asynchronously or independently from one another. One event may take away from the resource availability outlook while another event may contribute to the resource availability outlook.

At 506, performance metric can be estimated. For example, when each engagement execution is simulated, the engagement is recorded with simulated information such as arrival time, requested start date, resource allocated, actual start date, completion date, resource costs, revenue, profit, etc. At the end of a simulation run, for example, of a predetermined period, for instance, covering one year, the information associated with all the simulated engagements may be summarized to compute the performance metrics, e.g., whether allocated resources met the service order, profit, revenue requirements in a timely manner, etc. Based on the simulation results and the simulated input, it is possible to estimate performance of a service delivery operation.

In one aspect, effectiveness of the various optimizers may be determined from the results of the simulation and performance metrics. For instance, if a supply planning optimizer (FIG. 2, 216) determined an optimum value of the resource supply needed for a particular set of demand at a particular time period, and the supply planning simulator module 104 used that value in the simulation, the effectiveness of the optimizer's output can be determined by looking at the results of the simulation, evaluating whether the simulation resulted in fulfilling the service order on time, or whether the simulation resulted in not being able to fulfill the service order, etc. Effectiveness of other optimizers (e.g., FIG. 3 302, FIG. 4, 414) may be evaluated in the similar manner.

The system and method of the present disclosure may be implemented and run on a general-purpose computer or computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A computer implemented method for estimating performance of resource-based service delivery operation by simulating interactions of multiple events, comprising:
simulating a plurality of events associated with a resource-based service delivery operation; and
allowing the plurality of events to interact through a resource availability outlook,
wherein one or more results of the plurality of events interacting through a resource availability outlook can be used to estimate performance of resource-based service delivery operation.

2. The method of claim 1, wherein the plurality of events include events of engagement execution and at least one or more of demand planning of service engagement, supply planning of resources, attrition of resources, termination of resource or combination thereof.

3. The method of claim 1, further including:
simulating demand planning service engagement events, wherein the plurality of events include at least said demand planning service engagement events.

4. The method of claim 1, further including:
simulating supply planning of human resources events, wherein the plurality of events include at least said supply planning of human resources events.

5. The method of claim 1, further including:
simulating attrition of resources events, wherein the plurality of events include at least said attrition of resources events.

6. The method of claim 1, further including:
simulating termination of resource events, wherein the plurality of events include at least said termination of resource events.

7. The method of claim 1, further including:
simulating scheduling and fulfillment of service engagement events, wherein the plurality of events include at least said scheduling and fulfillment of service engagement events.

8. The method of claim 1, wherein the step of simulating further includes:
the plurality of events interacting with one or more policies associated with the resource-based service delivery operation.

9. The method of claim 1, wherein the step of simulating further includes:
simulating an impact of one or more policies on the plurality of events.

10. The method of claim 1, wherein the step of simulating further includes:
the plurality of events interacting with one or more optimizers associated with the resource-based service delivery operation.

11. The method of claim 1, wherein the method further includes:
determining effectiveness of one or more optimizers for the plurality of events.

12. The method of claim 1, wherein the step of allowing further includes:
allowing the plurality of events to asynchronously access and update the resource availability outlook.

13. The method of claim 1, further including:
estimating service operation performance metric associated with one or more of benched resource, resource utilization, engagement backlog, fulfillment delay, quality, revenue, profit, or combinations thereof.

14. A system for estimating performance of resource-based service delivery operation by simulating interactions of multiple events, comprising:
a processor operable to simulate a plurality of events associated with a resource-based service delivery operation, the processor further operable to allow the plurality of events to interact through a resource availability outlook.

15. The system of claim 14, further including:
a resource availability outlook storage operable to provide a resource availability outlook including at least information associated with current and future availability of resources.

16. The system of claim 14, wherein the processor includes:
an execution of service engagement simulation module and one or more of demand planning of service engagement simulation module, supply planning of resources simulation module, attrition of resources simulation module, termination of resource simulation module, or combinations of thereof.

17. The system of claim 14, wherein said plurality of events update the resource availability outlook asynchronously.

18. The system of claim 17, wherein said plurality of events interact with one or more policies.

19. The system of claim 17, wherein said plurality of events interact with a dynamic optimizer.

20. A program storage device readable by a machine, tangibly embodying a program of instructions executable by the machine to perform a method of estimating performance of resource-based service delivery operation by simulating interactions of multiple events, comprising:
simulating a plurality of events associated with a resource-based service delivery operation; and
allowing the plurality of events to interact through a resource availability outlook, the resource availability outlook providing availability view with respect to current time and future,
wherein one or more results of the plurality of events interacting through a resource availability outlook can be used to estimate performance of resource-based service delivery operation.
